(19) United States
(12) Patent Application Publication
(10) Pub. No.: US 2005/0037507 A1
(43) Pub. Date: Feb. 17, 2005

(54) Titration method

(76) Inventor: Christoph Gauer, Munchen (DE)

Correspondence Address: Rocco S Barrese;Dilworth & Barrese, 333 Earle Ovington Boulevard, Uniondale, NY, 11553, US

(21) Appl. No.: 10/501,501

(22) PCT Filed: Dec. 11, 2002
(86) PCT No.: PCT/EP02/14060

(30) Foreign Application Priority Data
Dec. 28, 2001 (DE) 10164357.8

(51) Int. Cl. G01N 31/22

(52) U.S. Cl. 436/163

(57) ABSTRACT

The invention relates to a titration method for extremely small quantities of liquid wherein a drop of an analyte held together by its surface tension is applied to the substantially flat surface of a solid, preferably a solid chip, a quantity of the titrant which is smaller than the quantity of the analyte drop, is brought in contact with the analyte drop for the reaction and a characteristic quantity for the reaction between titrant and analyte is measured during and/or after the reaction.

The invention relates to a titration method for liquids wherein an analyte is brought in contact with a titration quantity of a titrant and a parameter which changes during the reaction between the titrant and analyte is studied.

In biology and chemistry, extremely small quantities of liquid must frequently be analysed in this way. Possible measured quantities for example are the pH of the liquid, the concentration of molecules having oxidising or reducing groups or also of heavy metals.

Frequently, only extremely small quantities of the materials to be studied are available. In order to be able to make quantitative studies, the titrant must be supplied to the analyte in very small quantities in order: to be able to investigate as accurately as possible the change in parameters of the mixture caused by adding the titrant as a function of the quantity of titrant. If only a small amount of material is available, for accurate titration many drops of small volume of the titrant must be produced reproducibly and successively combined with the analyte. With increasingly smaller volumes, the flows are increasingly laminar. Thus, at small volumes mixing of the analyte with the titrant is found to be increasingly difficult.

The object of the present invention is to provide a titration method that is reproducible even with extremely small volumes of liquid in the range between one nanolitre and a few microlitres and with which reliable titration can be performed.

This object is solved using a titration method having the features of claim 1. The dependent claims are directed towards advantageous embodiments.

According to the invention a drop of the analyte held together by its surface tension is applied to a substantially flat surface of a solid. A titration quantity of the titrant is brought in contact with the analyte drop, wherein the quantity of the titrant is smaller than the quantity of the analyte drop. During or after the reaction a characteristic quantity for the reaction between titrant and analyte is measured. If necessary, another small titration quantity of the titrant is brought in contact with the analyte, in order to determine the change in the measured quantity with increasing quantity of titrant.

For the purposes of the present document the term “solid” designates both solids of crystalline material, e.g. LiNbO₃ or quartz, as well as structures made of other materials, e.g. plastic.

Both titrant and analyte can comprise among other things pure liquids, mixtures, dispersions or suspensions as well as liquids in which solid particles are located. Likewise, the titrant or the analyte can contain biological material, e.g., cells, macromolecules, proteins, antibodies, antigens or DNA.

In the method according to the invention, the analyte is a single drop which is held together by its surface tension. There is no need for any reaction vessels which could negatively influence the titration, for example, by adhesion. There is no edge interaction with any side walls of the vessel and it is possible to titrate very small quantities of liquid.

The method according to the invention allows macroscopic titration to be miniaturised by several orders of magnitude. With a limited quantity of sample, the concentration can be very much higher so that the method according to the invention is suitable for detecting extremely small quantities of samples or for analysing extremely small volumes. As a result of the small volumes in the range of a few nanolitres, the diffusion lengths are small and the reaction times are short.

The measured quantity can, for example, be the conductivity, the pH or the reaction heat which vary when the titrant is added to the analyte. Furthermore, an indicator can be dissolved in the analyte which, for example, brings about a colour change. At a certain concentration ratio between titrant and analyte in the analyte drop, a colour change is brought about by this indicator. Other measured quantities known from macroscopic titration can also be used.

The method according to the invention is preferably carried out on a solid chip, as is known, for example, from semiconductor technology. Such chips can be processed very simply using known techniques and allow electrodes or functionalised layers, for example, to be applied using known lithographic techniques. Such chip units can be used as part of “lab-on-the-chip” technology (see O. Müller, Laborwelt 1/2000, pages 36-38) in the miniaturisation of chemical and biological processes. A plurality of analysis stations can be arranged on such a chip with which the titration method according to the invention can be carried out or other analytical steps can be performed. In addition, integration with other units of a lab-on-the-chip can easily be achieved.

If the titration quantity of the titrant is applied to the surface, for example, using a pipetting robot or a piezodispenser, the small quantity of the analyte drop is already partly mixed by the impact of the titre solution on the analyte. In order to promote the reaction between titrant and analyte or mix liquid located at an analysis point, a surface acoustic wave is advantageously launched in the direction of the analysis point during the reaction between analyte and titrant. The momentum transfer of a surface acoustic wave sets the liquid on the surface in motion and results in its thorough mixing. In this case, the momentum of the surface acoustic wave is brought about by the mechanical deformation of the surface or by the interaction of changes in the electric field caused by the mechanical deformation of the surface with charged or polarisable particles which may be present in the liquid.

The titrant can be brought in contact with the analyte drop in drops using a pipetting robot or piezodispenser. However, it is especially simple and advantageous if drops of the titrant are moved on the surface of the solid itself in the direction of the analyte. The movement of the titration quantity towards the analyte drop can also be triggered with the aid of a surface acoustic wave. The movement on the surface by the momentum transfer of a surface acoustic wave makes it possible to achieve a particularly directional and defined movement. The suitable frequency of the surface acoustic wave depends on the diameter of the drop to be moved and can be determined, for example, in preliminary experiments.

The surface acoustic waves advantageously used for mixing the liquid at the analysis point and/or for moving the titration quantity of the titrant towards the analysis point can be generated using one or a plurality of interdigital transducers on a piezoelectric solid surface, whose direction of emission preferably corresponds to the direction of the desired momentum transfer. Such a piezoelectric surface can, for example, be formed from an LiNbO₃ or quartz crystal. Equally, a piezoelectric coating, e.g. ZnO, comprising another material can be provided. The surface can also be provided with a sufficiently thin biocompatible protective layer. In general, the use of interdigital transducers to generate surface acoustic waves to move small quantities of liquid is described in DE-A-100 55 318.

In a simple arrangement of this preferred embodiment, a drop of the titrant is applied to the solid surface, which drop is held together by its surface tension. For the titration the small quantity of the titrant is removed from this drop and supplied to the analyte drop at the analysis point wherein this small titration quantity of the titrant moves on the surface. This guarantees a higher reproducibility of the drop size than when using a known dispenser and a higher accuracy of impact of the titration quantity on the analyte drop.

The analyte is advantageously brought onto a specially functionalised analysis point on the solid surface whose area is more strongly wetted by the analyte than the surrounding solid surface. Such an analysis point holds the drop of analyte at a predetermined point so that any flowing apart or drifting away of the analyte is prevented.

The titrant drop serving as a reservoir from which the small titration quantity of the titrant supplied to the analyte drop is removed can be located on an anchor point on the surface of the solid, which is better wetted with the titrant liquid that its surrounding solid surface. In this way, it is ensured that the titrant remains at a certain point on the surface and does not leave this without the action of an external force.

The titration quantity of the titrant which is supplied to the analyte can advantageously be moved on the solid surface along a path whose surface is better wetted with the titrant than its surrounding surface. The titration quantity preferably moves on this path so that a controlled movement is ensured. Such a path can be achieved, for example, by modulation of the wetting properties as is described for the movement of quantities of liquids on surfaces in DE-A-100 55 318.

In order to separate a small quantity of the titrant from the reservoir drop at the anchor point, the reservoir drop at the anchor point can be guided over a path which is connected to the anchor point and/or the analysis point wherein the connection comprises a region which is so narrow that as a result of its surface tension the reservoir drop at the anchor point cannot leave the anchor point without the action of an external force. If the reservoir drop is driven on this path to this narrow point by the action of an external force, it breaks away in a defined fashion.

Alternatively, a reservoir drop can also be moved on the surface by the transfer of momentum, for example, over one or a plurality of small surface part regions, which are more strongly wetted by the titrant liquid than their surroundings. The area of this surface part region is selected to be so small that it is smaller than the contact area of the drop with the surface. If the reservoir drop is guided once or many times over such surface part regions, a small quantity of the titrant remains at these retaining points and can be moved towards the analyte drop for titration. Thus, a small titration quantity can be separated in a very simple and reproducible fashion.

In order to prevent the small quantities of liquid from vaporising too rapidly, the titration method is advantageously carried out in a climatic chamber to maintain defined thermodynamic boundary conditions.

The method according to the invention makes it possible to miniaturise the macroscopic titration. Volumes in the range of a few nanolitres to several microlitres can be titrated. In particular, when using surface acoustic waves, in addition to movement of the titrant on the surface the surface acoustic wave can be used for thorough mixing to make the titration result more reproducible.

Methods of analysis such as Scintillation Proximity Assay (SPA) or Fluorescence Resonance Energy Transfer (FRET) such as are described in J. Osborn, Life Science News, March 2001, pages 1-4, “A review of radioactive and non-radioactive-based techniques used in life science applications—Part II High-throughput screening”, can also be carried out particularly advantageously using the method according to the invention.

The invention is explained in detail with reference to particular embodiments which are shown schematically and not to scale in the appended drawings. In the figures:

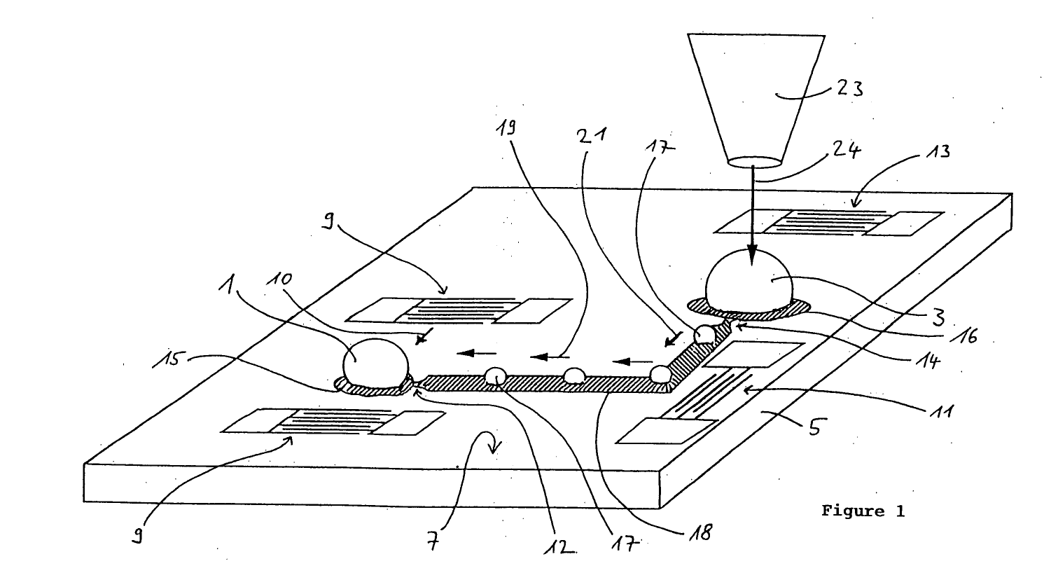

FIG. 1 shows the implementation of the titration method according to the invention,

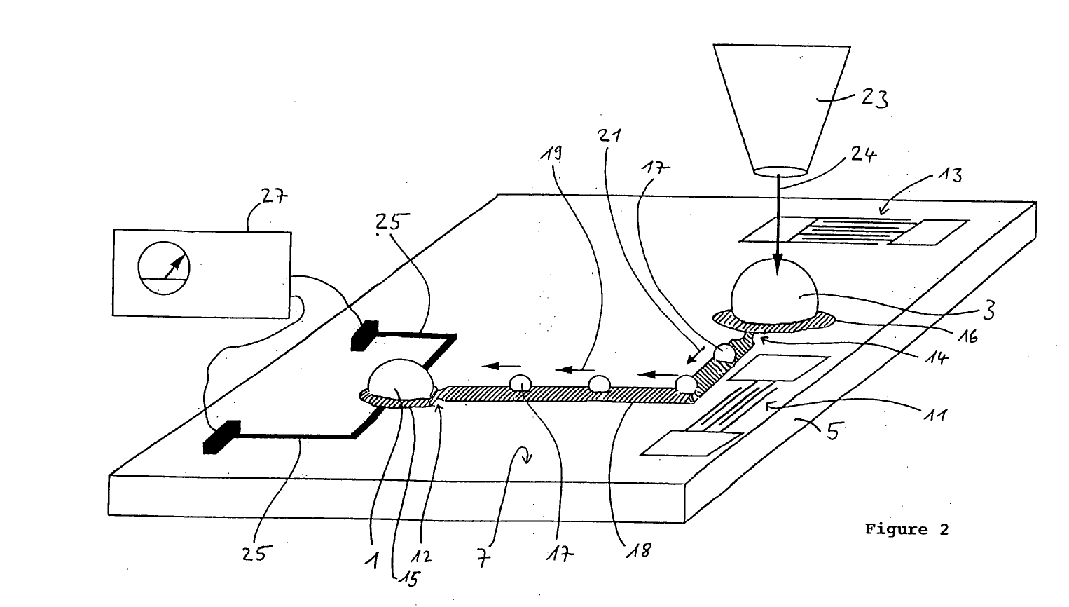

FIG. 2 shows another embodiment of the titration method according to the invention,

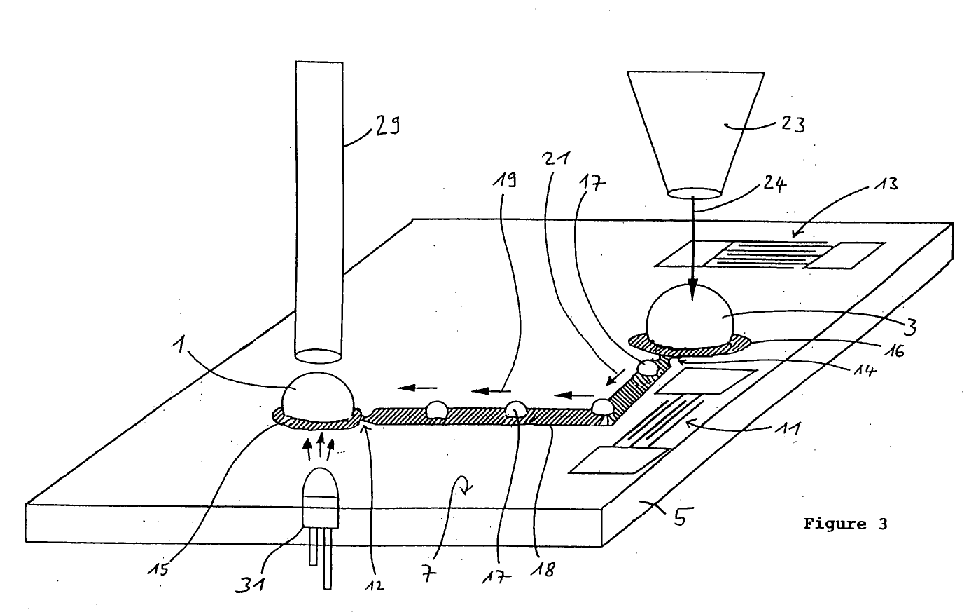

FIG. 3 shows a further embodiment of the titration method according to the invention and

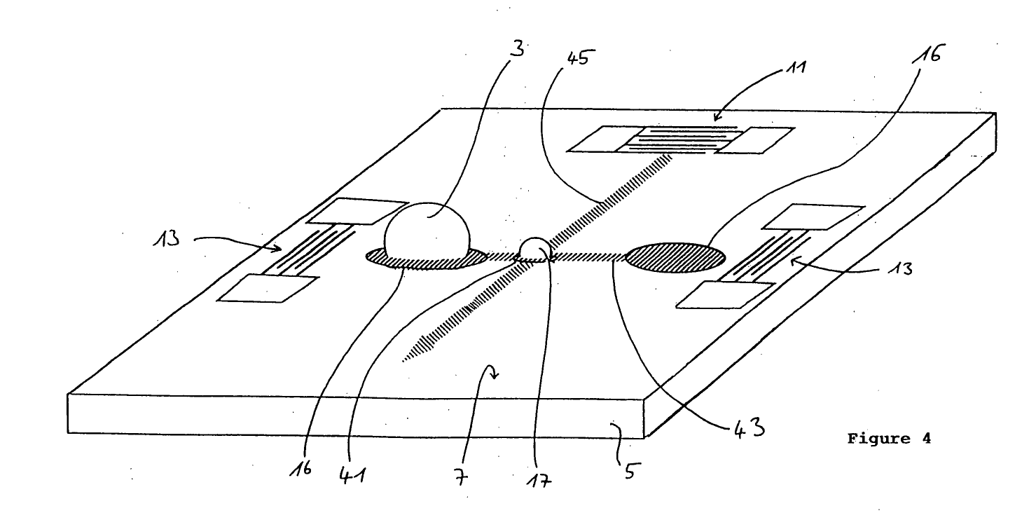

FIG. 4 shows a process step in a preferred embodiment of the titration method according to the invention.

FIG. 1 shows a solid chip, e.g. a piezoelectric lithium niobate chip 5, on whose surface 7 the titration method according to the invention can be carried out. A drop 1 of an analyte in the order of magnitude of. 0.5 nl to 100 nl is located on an analysis point 15 whose wetting properties differ from those of its surroundings. If the analyte comprises, for example, an aqueous solution, the analysis point 15 is hydrophilic compared to the surrounding solid surface. This can be achieved for example by the surrounding surface being made hydrophobic by silanisation. An analysis point with an area of, for example 100 μm x 100 μm is suitable for a typical quantity of liquid of 0.5 nl to 10 nl.

A reservoir drop 3 of the titrant solution is located at an anchor point 16. The anchor point 16 is also arranged such that it is more strongly wetted with the titrant solution than the surrounding solid surface.

The analysis point 15 and anchor point 16 are interconnected via a path 18 which also exhibits such wetting properties that it is better wetted with the titrant solution than the surrounding solid surface. The path 18 is constricted at the narrow points 14, 12 such that as a result of its surface tension, the drop located at the anchor point 16 or the analysis point 15 cannot leave the analysis point 15 or the anchor point 16 without the action of an external force.

9, 11 and 13 denote interdigital transducers which are suitable for exciting surface acoustic waves on the surface 7 of the lithium niobate crystal 5. In their simplest form the interdigital transducers consist of two electrodes with finger-like intermeshing continuations. Applying an alternating field of the order of magnitude of 100 MHz to the electrodes of one interdigital transducer results in excitation of a surface acoustic wave having a wavelength corresponding to the finger spacing of the finger-like intermeshing electrodes and whose direction of propagation is substantially perpendicular to the finger electrodes. In the case of the interdigital transducer 9, this is indicated schematically for example by the arrow 10. Each transducer comprises a large number of intermeshing fingers of which respectively only a few are shown schematically and not to scale. Other transducer geometries can also be used, as are known from the technology of the surface acoustic wave filter.

The interdigital transducers 9 are aligned such that a surface acoustic wave excited by them moves towards the analysis point 15. The interdigital transducer 11 produces a surface acoustic wave in the direction 19. The interdigital transducer 13 ultimately produces a surface acoustic wave in the direction 21. The electrical connections to the electrodes of the interdigital transducers which are provided in a conventional fashion are not shown for purposes of clarity.

In a schematic representation 23 shows the tip of an inherently known piezodispenser for applying the reservoir drop 3 of the titrant to the anchor point 16. The outflow of liquid from the dispenser tip 23 is indicated by the arrow 24.

Using the apparatus shown the method according to the invention can be carried out as follows.

First, a drop of the analyte 1 is applied to the analysis point 15 using a dispenser head tip not shown, which is similar to the dispenser tip 23. As a result of the specially selected wetting properties of the analysis point 15 compared with the wetting properties of the surrounding solid surface 7, the drop 1 which is held together by its surface tension does not leave the analysis point 15. A drop of the titrant 3 is applied to the anchor point 16 using the dispenser tip 23. Likewise as a result of its surface tension and the wetting properties of the anchor point compared to the wetting properties of the surrounding solid surface 7 (e.g. hydrophilic compared to the surrounding solid surface in the case of an aqueous titrant solution), this drop 3 does not leave the anchor point 16. The applied volumes of the analyte or the titrant can be in the range of one picolitre to several 100 microlitres.

An alternating frequency, e.g. a few 100 MHz is now applied to the interdigital transducer 13 so that a surface acoustic wave is generated in the direction 21. The momentum transfer of the surface acoustic wave moves the drop 3 in the direction of the narrow point 14 which connects the anchor point 16 to the path 18. A small quantity of the drop 3 moves over the narrow point 14 and breaks away in a defined fashion with suitable dimensioning. The required reduction in the width of the narrow point 14 can be determined, for example, by preliminary experiments. The separated quantity of titrant can be a few nanolitres example but should be less than about one tenth of the quantity of analyte at the analysis point 15.

The withdrawn part 17 of the titrant, the titration quantity, is also moved away from the anchor point 16 by momentum transfer of the surface acoustic wave generated using the interdigital transducer 13. The movement of the small titration quantity of the titrant towards the analysis point 15 is continued using a second transducer 11.

The small titration quantity 17 meets the analyte drop 1 at the analysis point 15. The reaction between titrant and analyte can be accelerated by using a surface acoustic wave generated by one of the interdigital transducers 9. The surface acoustic wave can be detected after passing through the analysis point 15 using a second interdigital transducer 9. As a result of the reaction of the analyte with the titrant, the attenuation of the surface acoustic wave may have changed for example so that information on the reaction can be obtained. In addition, by comparison with corresponding reference measurements the precise quantity of the analyte at the analysis point 15 can be determined from the attenuation of the surface acoustic wave.

In another embodiment of the method a surface acoustic wave can be launched towards the analysis point 15 from each of the interdigital transducers 9 in order to accelerate the reaction or effectively mix the liquid.

By means of a suitably pulsed surface acoustic wave generated using the interdigital transducer 13, a plurality of small titrant quantities 17 can be moved in a defined fashion towards the analysis point 15 in the manner described to carry out a titration 1.

A plurality of suitable devices can be provided in parallel on a chip so that a plurality of experiments can be carried out in parallel.

Among other things, ICT (Isothermal Calorimetric Titration) or DSC (Differential Scanning Calorimetry) can be carried out using the method according to the invention as described in a review article by I. Jelesarov and H. R. Bosshard in J. Mol. Recognit. 1999; 12: 3-18.

An alternative method is shown in FIG. 2. For the sake of clarity FIG. 2 does not show the transducer 9 which may be provided for thorough mixing. The same reference numbers denote otherwise the same elements as in FIG. 1. In the method shown in FIG. 2, the conductivity of the analyte 1 is measured for the titration. For this purpose, electrodes 25 connected to the analysis point 15 are provided on the surface 7 of the solid chip 5. Electrical connections lead to a conductivity measuring device 27. By successively adding titrant in small quantities 17 the conductivity of the analysis drop 1 changes, which can be determined using the conductivity measuring device 27. In order to carry out such a process sequence according to the invention, the analysis point 15 is made of a non-conductive material.

FIG. 3 shows another embodiment of the method according to the invention. An optical measurement is made instead of the conductivity measurement from FIG. 2. Again the transducers 9 which may be provided for thorough mixing are not shown. A light-emitting diode 31 or another suitable light source illuminates the solid chip 5 from below. For example, the optical signal is intercepted using a glass fibre 29 and passed on to an evaluation device not shown and evaluated in an inherently known fashion. Using this embodiment, for example, it is possible to measure the colour change of an analyte in which an indicator is dissolved which changes colour after adding a certain quantity of titrant. If a non-transparent substrate is used, the light path can also be selected as parallel to the surface 7 of the chip 5.

The embodiments of the method according to the invention described use the narrow point 14 in order to withdraw a defined quantity 17 of the titrant from the titrant 3. FIG. 4 shows an alternative possibility for separating a small quantity of titrant. The same reference numbers denote comparable elements as in FIGS. 1 to 3. A reservoir drop 3 is located on an anchor point 16. As a result of momentum transfer of a surface acoustic wave generated using the interdigital transducer 13 closest to the corresponding anchor point 16, the reservoir drop 3 is driven towards the second anchor point 16. The momentum transfer of another surface acoustic wave generated using the interdigital transducer 13 which is closest to the second anchor point drives the reservoir drop back again. In this case, said drop moves to and fro along the indicated section 43. It crosses a surface region 41 whose area is smaller than the contact area of the reservoir drop 3 with the solid surface 7 once or many times. This surface region 41 has such wetting properties that the liquid of the reservoir drop 3 wets this more strongly that its surrounding solid surface. After crossing the surface region 41 once or several times, a small titrant quantity 17 has separated from the reservoir drop 3. In the case of an aqueous titrant solution, the surface region 41 has hydrophilic properties for example.

After the small titrant quantity 17 has been separated from the reservoir drop 3 in this manner, with the aid of the momentum transfer of a surface acoustic wave which can be generated for example in direction 45 using an interdigital transducer 11, the titrant quantity 17 can be moved away from the surface region 41, e.g. towards an analysis point not shown in FIG. 4, in order to be combined there with the analyte drop, as has been described above with reference to FIGS. 1 to 3.

The reservoir drop 3 and the titrant drop 17 can in this case be moved along preferably wetted paths as have already been described with references to FIGS. 1 to 3 and are denoted there by the reference number 18. Such paths advantageously have a lateral expansion which is smaller than the diameter of the surface region 41. The method according to the invention and the separation of the small titrant quantity 17 described can however be carried out without such paths so that these are not shown in FIG. 4.

Using the method shown in FIG. 4, for example 20-picolitre small droplets 17 can be separated from a 50-nanolitre reservoir drop 3. A plurality of surface regions 41 can be provided along the path of the reservoir drop 3 if a plurality of titrant quantities 17 are to be separated simultaneously. Depending on the property of the liquid to be manipulated in the reservoir drop 3, suitable geometries for the surface region 41, e.g. circular or annular, can be determined by suitable preliminary tests.

The method described in FIG. 4 for separating a small titrant quantity 17 from a reservoir drop 3 can naturally also be combined with all the embodiments for the titration and the subsequent analysis which have already been described above.

1. A titration method for small quantities of liquid wherein
a) a drop (1) of the analyte held together by its surface tension is applied to a substantially flat surface (7) of a solid, preferably a solid chip (5),
b) a titration quantity (17) of the titrant, which is smaller than the quantity of the analyte drop (1), is brought in contact with the analyte drop (1) for the reaction,
c) a characteristic quantity for the reaction between titrant and analyte is measured during and/or after the reaction, and
d) if necessary, steps b) and c) are repeated.

2. The titration method according to claim 1, wherein during the reaction between analyte and titrant a surface acoustic wave is launched in the direction (10) of the analyte drop to promote the reaction between titrant and analyte or to thoroughly mix the analytes and titrants.

3. The titration method according to claim 2, wherein the titration quantity (17) of the titrant on the solid surface (7) is moved towards the analyte (1).

4. The titration method according to claim 3, wherein a reservoir drop (3) of the titrant is brought onto the solid surface (7) which is held together as a result of its surface tension and the titration quantity (17) of the titrant is separated from this reservoir drop (3) for titration and is supplied to the analyte drop (1).

5. The titration method according to claim 4, wherein the movement of the titration quantity (17) is triggered by the momentum transfer of a surface acoustic wave.

6. The titration method according to claim 2, wherein one or a plurality of interdigital transducers (9, 11, 13) on a piezoelectric solid surface (7) are used to generate the surface acoustic wave or surface acoustic waves with a direction of emission of the surface acoustic waves in the direction of the desired momentum transfer.

7. The titration method according to claim 4, wherein the drop (1) of the analyte is brought onto an analysis point (15) on the solid surface (7) whose surface is more strongly wetted by the analyte than the surrounding solid surface (7).

8. The titration method according to claim 7, wherein the reservoir drop (3) is applied to an anchor point (16) on the surface (7) of the solid (5), whose surface is more strongly wetted by the titrant than its surrounding solid surface.

9. The titration method according to claim 7, wherein the titration quantity (17) of the titrant is guided from the reservoir drop (3) of the titrant applied to the solid surface (7) on a path (18) to the analyte drop (1), where at least part of the surface of the path from the titrant is better wetted than the surface surrounding the path.

10. The titration method according to claim 9, wherein the titration quantity (17) of the titrant is connected from the reservoir drop (3) to the analyte drop (1) over a path (18), which is connected to the anchor point (16) and/or the analysis point (15), wherein the connection (14, 12) comprises a region which is so narrow that, as a result of its surface tension, the reservoir drop (3) on the anchor point (16) does not leave the anchor point (16) without the action of an external force.

11. The titration method according to claim 4, wherein the reservoir drop (3) is moved at least once over at least one region (41) of the surface (7), which is more strongly wetted by the liquid than the surrounding surface, wherein the area of this region (41) is smaller than the contact area of the reservoir drop (3) with the surface in order to separate a titration quantity (17) from the reservoir drop (3).

12. The titration method according to claim 1, which is carried out in a climatic chamber to control the thermodynamic boundary conditions.

13. The titration method according to claim 1, wherein a surface acoustic wave is launched in the direction (10) of the analysis point (15) during and/or after the reaction between titrant and analyte (1) and the change in one or a plurality of parameters of the surface acoustic wave as a result of the interaction with the liquid at the analysis point (15) is measured.

14. The titration method according to claim 1, wherein the reaction heat is determined during the reaction between titrant and analyte.

15. The titration method according to claim 1, wherein the characteristic quantity in step c) comprises the electrical conductivity.

16. The titration method according to claim 1, wherein the characteristic quantity in step c) comprises a colour change.

17. The titration method according to claim 1, wherein the characteristic quantity in step c) comprises the pH.

18. The titration method according to claim 3, wherein one or a plurality of interdigital transducers (9, 11, 13) on a piezoelectric solid surface (7) are used to generate the surface acoustic wave or surface acoustic waves with a direction of emission of the surface acoustic waves in the direction of the desired momentum transfer.

19. The titration method according to claim 4, wherein one or a plurality of interdigital transducers (9, 11, 13) on a piezoelectric solid surface (7) are used to generate the surface acoustic wave or surface acoustic waves with a direction of emission of the surface acoustic waves in the direction of the desired momentum transfer.

20. The titration method according to claim 5, wherein one or a plurality of interdigital transducers (9, 11, 13) on a piezoelectric solid surface (7) are used to generate the surface acoustic wave or surface acoustic waves with a direction of emission of the surface acoustic waves in the direction of the desired momentum transfer.
